(19) United States
(12) Patent Application Publication
(10) Pub. No.: US 2026/0117865 A1
(43) Pub. Date: Apr. 30, 2026

(54) Synchronous Rotation Gapless Piston Rings

(71) Applicant: LF International, Inc., Afton, TN (US)

(72) Inventors: Ted Hollinger, Greenville, TN (US); Bahman Lashkari, New York, NY (US); Ellington Ellis, Afton, TN (US); C. Jefferson Ingram, Greeneville, TN (US)

(73) Assignee: LF International, Inc., Afton, TN (US)

(21) Appl. No.: 19/371,547

(22) Filed: Oct. 28, 2025

Related U.S. Application Data
(60) Provisional application No. 63/713,254, filed on Oct. 29, 2024.

(51) Int. Cl. F16J 9/16

(52) U.S. Cl. CPC F16J 9/16

(57) ABSTRACT

A piston ring set having first and second rings. The first ring has a stop extending with a width, length, and depth. The width is the distance around the circumference of the ring, and the length is a distance between the inner circumference and the outer circumference. The depth is a distance between the surface of the ring and the top of the stop. A second ring has a notch with a width, length, and depth. The width is the distance around the circumference of the ring, and the length is the distance between the inner circumference and the outer circumference of the ring. The depth is the distance between the surface of the ring and the bottom of the notch. The stop of the first ring engages the notch of the second ring, causing any rotation of the first ring and the second ring to be synchronous.

### FIELD

This invention relates to the field of internal combustion engine (ICE) parts. More particularly, this invention relates to piston rings.

### INTRODUCTION

In standard ICE design, a piston ring is a band of one or more materials—typically including metal—that fits within a circumferential groove near the top of the piston. The ring is sized so that it makes a snug but non-binding fit against the cylinder wall, so that it can slide up and down with the piston within the cylinder. One purpose of the ring is to prevent—as much as possible—the venting of pressurized exploding gases between the piston and the cylinder wall. In so doing, the ring helps to increase the power and efficiency of the ICE. Another purpose of the ring is to keep the engine oil that is lubricating the components below the piston, from entering the space above the piston face.

Standard piston rings are not a continuous ring, but instead include a split or gap in the ring, such that the ring can expand and contract with temperature as needed, so as to fit snugly against the cylinder wall. Unfortunately, gases and oil can pass through the gap in the piston ring, thereby lowering its overall efficiency. Thus, a piston ring that has no gap would be advantageous.

Nowadays, some ring configurations are actually two independent rings, each with a standard gap, where the two rings are placed into the same circumferential piston groove. Each ring can rotate independently within the groove around the piston, which rotation is desirable to avoid seizing. Each ring typically rotates completely around the piston head every few minutes. In practice, they tend to rotate at different speeds, and thus, at times, the gap in one ring will line up with the gap in the other ring. When the gaps are aligned, they allow gases and oil to blow by the ring combination. Thus, these configurations do tend to increase efficiency, but not as much as might be desired.

What is needed, therefore, is a ring or ring combination that tends to reduce issues such as those described above, at least in part.

### SUMMARY

The above and other needs are met by a piston ring set having a first ring and a second ring. The first ring has a stop extending from a first surface of the first ring, the stop having a first width, first length, and first depth. The first width is defined as a first distance around an outer circumference of the first ring, and the first length is defined as second distance between an inner circumference of the first ring and the outer circumference of the first ring. The first depth is defined as a third distance between the first surface of the first ring from which the stop extends and a distal end of the stop. A second ring has a notch formed in a first surface of the second ring, the stop having a second width, second length, and second depth. The second width is defined as a fourth distance around an outer circumference of the second ring, the second length is defined as fifth distance between an inner circumference of the second ring and the outer circumference of the second ring, and the second depth is defined as a sixth distance between the first surface of the second ring in which the stop is formed and a bottom end of the notch. The stop of the first ring engages the notch of the second ring, causing any rotation of the first ring and the second ring to be synchronous.

In various embodiments according to this aspect of the disclosure, the first ring is a top ring and the second ring is a bottom ring. In some embodiments, the first width of the stop is equal to the second width of the notch, plus normal end gap dimension. In some embodiments, the first width of the stop is less than the second width of the notch. In some embodiments, the first length is less than a width of the first ring between the inner circumference of the first ring and the outer circumference of the first ring. In some embodiments, the first length is equal to a width of the first ring between the inner circumference of the first ring and the outer circumference of the first ring. In some embodiments, the second length is less than a width between the inner circumference of the second ring and the outer circumference of the second ring. In some embodiments, the second length is equal to a width between the inner circumference of the second ring and the outer circumference of the second ring.

In some embodiments, the first length of the stop is equal to the second length of the notch. In some embodiments, the first length of the stop is less than the second length of the notch. In some embodiments, the first depth of the stop is equal to the second depth of the notch. In some embodiments, the first depth of the stop is less than the second depth of the notch. In some embodiments, the corners of the stop are chamfered. In some embodiments, the corners of the stop are orthogonal. In some embodiments, the corners of the notch are chamfered. In some embodiments, the corners of the notch are orthogonal.

According to another aspect of the disclosure, there is described a piston ring having a non-continuous circular band of material, with a first end and second end, a width, and a depth. The width is defined as a distance between an inner circumference of the ring and outer circumference of the ring, and the depth is defined as a distance between a top surface of the ring and a bottom surface of the ring. The first end forms a first extension and a second extension, where the first extension extends longer than the second extension.

The first extension has a first width extending from one of the inner circumference or the outer circumference to a first position between the inner circumference and the outer circumference, and also having a first depth extending from the top surface of the ring to a second position between the top surface and the bottom surface. The second extension has a second depth extending from the bottom surface of the ring to the second position.

The second end forms a third extension and a fourth extension, where the third extension extends longer at the second end than the fourth extension. The third extension has a second width extending from an opposing circumference than that from which the first width is measured, where the second width and the first width equal the width of the ring. The third extension also has a third depth extending from the top surface of the ring to the second position. The fourth extension has a second depth extending from the bottom surface of the ring to the second position.

The first extension engages the fourth extension and the second extension engages the third extension, thereby sealing off any gaps from extending completely through the piston ring.

In various embodiments according to this aspect of the disclosure, the first extension engages the fourth extension and the second extension engages the third extension in such a manner that the ring can expand and contract without binding. In some embodiments, the ring is formed of a uniform material. In some embodiments, the ring is formed of different layers of material.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is an outside perspective view of a top of a ring according to an embodiment of the present disclosure.

FIGS. 2-8 are side elevational views from the inside, of top rings with stops and complimentary bottom rings with notches, according to various embodiments of the present disclosure.

### DESCRIPTION

With reference now to the drawings, there are depicted all of the claimed elements of the various embodiments, although all claimed embodiments might not be depicted in a single drawing. Thus, it is appreciated that not all embodiments include all of the elements as depicted, and that some embodiments include different combinations of the depicted elements. It is further appreciated that the various elements can all have many different configurations, and are not limited to just the configuration of a given element as depicted. As indicated above, the elements of the drawings as depicted are not to scale, even with respect one to another, and relative size or thickness of one element cannot be determined by the aspect ratios of that element or with reference to any dimension of another element.

### Overview

As described herein, the main surfaces of a piston ring are the sides, which are the top and bottom faces as the ring sits around the piston; the face or outer circumference, which contacts the cylinder wall; and the back or inner circumference, which fits against the inside face of the piston groove. Rings are typically thinner (flatter) as measured between the sides (top to bottom), and thicker (wider) as measured between the back and the face (inner and outer circumferences). Faces can have a variety of different profiles, including: rectangular, which is a basic, flat, orthogonal, squared face; tapered, which is a slight angle or bevel between one side and the flat of the face, which is designed to help with running-in and oil scraping; and keystone, which is a trapezoidal shape that is tapered on both sides of the face, and is generally helpful to prevent sticking.

All of the rings described herein can be made of a variety of different materials, have a variety of different thicknesses, widths, diameters, and face designs, and a variety of different coatings or other finishes, all as are known in the art. The embodiments described herein include both a single-piece ring and multipart ring sets, where the multipart rings are designed so the top ring and the bottom ring rotate synchronously, thereby preventing any gap from forming completely through the two rings.

The single-piece ring can replace a standard top ring (also known as a compression ring) without any ICE or piston modifications.

The multipart set of rings are arranged to form a gap-free combination, where each ring is free to rotate, but only in unison (synchronously) with each other. This set of rings replaces standard and other forms of rings, and provides a better seal that delivers increased ICE efficiency, as compared to prior art rings.

A technician can choose the ring design that best meets his needs, and replace traditional rings with the gap-free rings as described herein. Once this is done, a tighter seal is achieved, leading to higher power, higher efficiency, and lower emissions. In some embodiments, gap-free top rings can eliminate the need for a second compression ring, and thus enable the design of two-ring pistons. This can reduce costs by eliminating the second ring and the second ring groove in the piston, and allow the piston to be shorter, with less weight.

### Single Ring

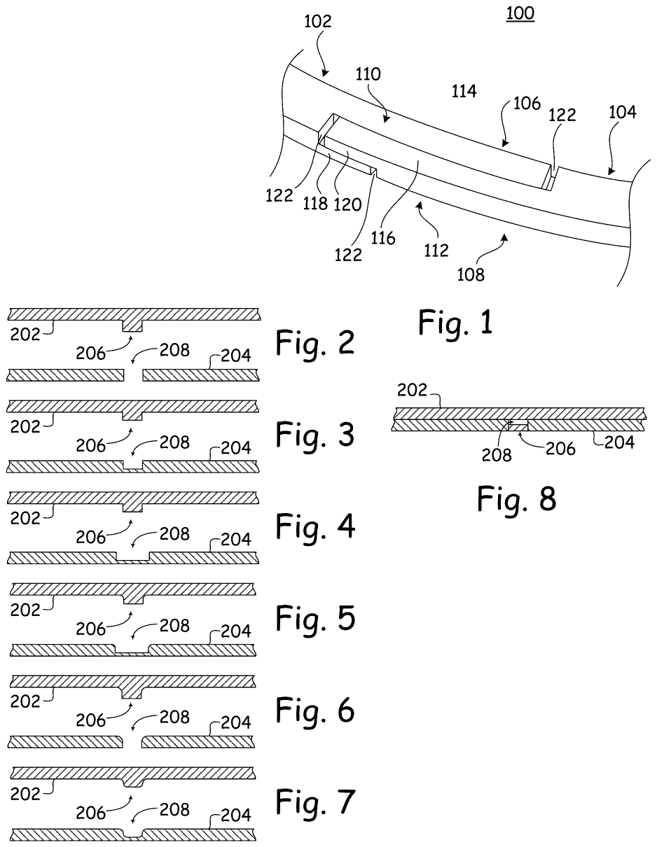

With reference now to FIG. 1, there is depicted a piston ring 100 having overlapping ends 102 and 104, with a compound gap disposed between the two ends 102 and 104, as further described herein.

The ring 100 can include some typical elements of a prior art ring, such as width, thickness, edge shapes, materials, and coatings. Each end 102 and 104 of the ring 100 is designed with no direct gap horizontally from the inside 106 of the ring 100 to the outside 108 of the ring 100, or vertically from the top 110 of the ring 100 to the bottom 112 of the ring 100.

This is accomplished by forming the two ends 102 and 104 with complimentary tangs or extensions 114 and 116, each with a lip 120 (only visible on end 104 as depicted in FIG. 1) that mates with a complimentary lip 118 (only visible on end 102 as depicted in FIG. 1). These elements form four gaps 122 (only three of which are visible in FIG. 1), that allow the ring 100 to expand and contract in diameter within the piston groove, without forming a direct gap through the ring 100 from the top 110 to the bottom 112, or from the inside 106 to the outside 108 of the ring 100.

### Multi-Ring System

FIGS. 2-8 depict embodiments that include an upper ring 202 having at least one stop 206 depending downward, and a lower ring 204 having at least one notch 208, where the stop 206 from the top ring 202 fits into the notch 208 in the bottom ring 204.

In some embodiments the notches 208 are wider than the stops 206, which allows the upper ring 202 and the lower ring 204 to rotate to a limited extent, one to another, depending at least in part upon the desired widths of both the stops 206 and the notches 208, such as but not limited to +/−5 degrees. Thus, the lower ring 204 is designed to both rotate in synchronization with the upper ring 202, and also be free to move slightly relative to the upper ring 202. Both of these movements tend to keep the rings 202 and 204 from seizing, and allow them to clean the piston groove in which they reside.

Various ones of the FIGS. 2-8 also depict square-faced stops 206 and notches 208, chamfered stops 206 and notches 208, longer stops 206 that extend through notches 208 that are formed completely through the lower ring 204, and shorter stops 206 that fit into notches 208 that do not extend completely through bottom ring 204.

The upper ring 202 can be formed of one or more pieces, and be formed of a different material than the lower ring 204. The upper ring 202 can be a different thickness than the lower ring 204. It also appreciated that the top ring 202 could have the notch 208, while the bottom ring 204 has the stop 206.

The stops 206 and notches 208 are placed on the inside of the rings 202 and 204, to keep the stops 206 and notches 208 from exposure to the high temperature gases at the cylinder wall, and to allow the rings 202 and 204 to move outward as needed. The distance the stop 206 extends from the inside edge of the top ring 202, and the distance the notch 208 extends from the inside edge of the bottom ring 204 determines how far the ring 202, 204 can expand outward before disengaging from each other and allowing the rings 202, 204 to rotate asynchronously. This dimension is usually set for cylinder wear of about 0.030″ in diameter.

The stops 206 can be integral, added, stamped, or otherwise reformed. The stops 206 and notches 208 can be made in a wide variety of sizes and shapes, so long as they force the rings 202, 204 to rotate in sync with each other. It is also possible to place the stops and notches other than on the inside edge of the rings 202, 204.

One method for establishing the depth of the stop 206, that is—the distance from the inside edge of the ring 202 to the outside of the stop 206, can be calculated as follows; first find the cylinder diameter, piston diameter, piston ring groove depth, and width of the ring 202. The stop 206 depth in one embodiment is (piston groove depth−ring width)+ (cylinder diameter−piston diameter)/2+ (cylinder diameter after wear-initial cylinder diameter)/2. As an example, for a 4.000″ piston, 4.030″ cylinder, 0.188″ deep ring groove and 0.184 ring width, the equations yields (0.188″−0.184″)+ (4.030″−4.000″)/2+ (4.060″−4.030″)/2, or 0.004″+0.015″+0.015″=0.034″.

The width of the stop 206 and matching notch 208 can be determined in one embodiment by deciding how many degrees of rotation each should have relative to the other. As an example, if the notch 208 is to be five degrees wide, and the stop 206 two degrees wide, then calculate the circumference of the piston, which is pi times the diameter of the piston. This is 12.56″ for the example given in the paragraph above. Then divide the 12.56″ by 360 degrees to get 0.035″ per degree. The notch 208 is then 0.175″ and the stop 206 is 0.070″ wide. This allows a movement of +/−1.5 degrees. This is a non-limiting example, and a different set of dimensions and degrees is also contemplated.

In another embodiment, as depicted in FIG. 8, the stop 206 is relieved at the back so that the stop 206 appears as an island. This can be done to allow the lower ring 204 to have square ends in the notch 208, and thus reduce machining time.

As used herein, the phrase “at least one of A, B, and C” means all possible combinations of none or multiple instances of each of A, B, and C, but at least one A, or one B, or one C. For example, and without limitation: Ax1, Ax2+Bx1, Cx2, Ax1+Bx1+Cx1, Ax7+Bx12+Cx113. It does not mean Ax0+Bx0+Cx0.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A piston ring set having a first ring and a second ring, the ring set comprising:
the first ring having a stop extending from a first surface of the first ring, the stop having a first width, first length, and first depth, where
the first width is defined as a first distance around an outer circumference of the first ring,
the first length is defined as second distance between an inner circumference of the first ring and the outer circumference of the first ring, and
the first depth is defined as a third distance between the first surface of the first ring from which the stop extends and a distal end of the stop,
a second ring having a notch formed in a first surface of the second ring, the stop having a second width, second length, and second depth, where
the second width is defined as a fourth distance around an outer circumference of the second ring,
the second length is defined as fifth distance between an inner circumference of the second ring and the outer circumference of the second ring, and
the second depth is defined as a sixth distance between the first surface of the second ring in which the stop is formed and a bottom end of the notch,
where the stop of the first ring engages the notch of the second ring, causing any rotation of the first ring and the second ring to be synchronous.

2. The piston ring set of claim 1, wherein the first ring is a top ring and the second ring is a bottom ring.

3. The piston ring set of claim 1, wherein the first width of the stop is equal to the second width of the notch.

4. The piston ring set of claim 1, wherein the first width of the stop is less than the second width of the notch.

5. The piston ring set of claim 1, wherein the first length is less than a width of the first ring between the inner circumference of the first ring and the outer circumference of the first ring.

6. The piston ring set of claim 1, wherein the first length is equal to a width of the first ring between the inner circumference of the first ring and the outer circumference of the first ring.

7. The piston ring set of claim 1, wherein the second length is less than a width between the inner circumference of the second ring and the outer circumference of the second ring.

8. The piston ring set of claim 1, wherein the second length is equal to a width between the inner circumference of the second ring and the outer circumference of the second ring.

9. The piston ring set of claim 1, wherein the first length of the stop is equal to the second length of the notch.

10. The piston ring set of claim 1, wherein the first length of the stop is less than the second length of the notch.

11. The piston ring set of claim 1, wherein the first depth of the stop is equal to the second depth of the notch.

12. The piston ring set of claim 1, wherein the first depth of the stop is less than the second depth of the notch.

13. The piston ring set of claim 1, wherein corners of the stop are chamfered.

14. The piston ring set of claim 1, wherein corners of the stop are orthogonal.

15. The piston ring set of claim 1, wherein corners of the notch are chamfered.

16. The piston ring set of claim 1, wherein corners of the notch are orthogonal.

17. A piston ring, comprising:
a non-continuous circular band of material having a first end and second end, a width, and a depth, where
the width is defined as a distance between an inner circumference of the ring and outer circumference of the ring, and
the depth is defined as a distance between a top surface of the ring and a bottom surface of the ring,
the first end forming a first extension and a second extension,
the first extension extending longer at the first end than the second extension, the first extension having a first width extending from one of the inner circumference or the outer circumference to a first position between the inner circumference and the outer circumference, and also having a first depth extending from the top surface of the ring to a second position between the top surface and the bottom surface, and
the second extension having a second depth extending from the bottom surface of the ring to the second position, and
the second end forming a third extension and a fourth extension,
the third extension extending longer at the second end than the fourth extension, the third extension having a second width extending from an opposing circumference than that from which the first width is measured, where the second width and the first width equal the width of the ring, and also having a third depth extending from the top surface of the ring to the second position, and
the fourth extension having a second depth extending from the bottom surface of the ring to the second position,
where the first extension engages the fourth extension and the second extension engages the third extension, thereby sealing off any gaps from extending completely through the piston ring.

18. The piston ring of claim 17, wherein the first extension engages the fourth extension and the second extension engages the third extension in such a manner that the ring can expand and contract without binding.

19. The piston ring of claim 17, wherein the ring is formed of a uniform material.

20. The piston ring of claim 17, wherein the ring is formed of different layers of material.
